(19) United States
(12) Patent Application Publication
(10) Pub. No.: US 2016/0006163 A1
(43) Pub. Date: Jan. 7, 2016

(54) WATERPROOF CONNECTOR

(71) Applicant: YAZAKI CORPORATION, Tokyo (JP)

(72) Inventors: Harunori TASHIRO, Shizuoka (JP); Tomoharu SUZUKI, Shizuoka (JP)

(73) Assignee: YAZAKI CORPORATION, Tokyo (JP)

(21) Appl. No.: 14/851,570

(22) Filed: Sep. 11, 2015

Related U.S. Application Data
(63) Continuation of application No. PCT/JP2014/056244, filed on Mar. 11, 2014.

(30) Foreign Application Priority Data
Mar. 14, 2013 (JP) 2013-051542

(51) Int. Cl. H01R 13/52

(52) U.S. Cl. CPC H01R 13/5208; H01R 13/5216

(57) ABSTRACT

A waterproof connector has a fitting portion fitted with a mating connector, a connector housing including a filling chamber in which a connection portion is accommodated and a filler is filled and a cable drawing portion from which a cable is drawn out from an inside of the filling chamber, a rear holder assembled to the cable drawing portion and holding the cable together with the cable drawing portion, and a seal cap assembled to the cable between the cable drawing portion and the filling chamber and preventing outflow of the filler from the inside of the filling chamber. Holding recess portions for deforming the seal cap and for bringing the seal cap into close contact with an outer periphery of the cable in a state in which the rear holder is assembled to the cable drawing portion are provided on the cable drawing portion and the rear holder.

### CROSS REFERENCE TO RELATED APPLICATIONS

This application is a Continuation of PCT Application No. PCT/JP2014/056244, filed on Mar. 11, 2014, and claims the priority of Japanese Patent Application No. 2013-051542, filed on Mar. 14, 2013, the content of both of which is incorporated herein by reference.

### TECHNICAL FIELD

The present invention relates to a waterproof connector in which a connection portion between an end of a cable and a terminal is waterproofed by a filler.

### BACKGROUND ART

FIGS. 18 to 20 illustrate a waterproof connector 1 having a structure proposed in Patent Literature 1. This waterproof connector 1 has a fitting portion 2 fitted with a mating connector, a connector housing 8 including a filling chamber 6 in which a connection portion 5 between an end of a cable 3 and a terminal 4 is accommodated and a filler is filled and a cable drawing portion 7 in which the cable 3 is drawn out from an inside of the filling chamber 6, a rear holder 9 assembled to the cable drawing portion 7 and holding the drawn out cable 3 together with the cable drawing portion 7, and a seal cap 10 assembled to the cable 3 between the cable drawing portion 7 and the filling chamber 6 and preventing outflow of the filler from the inside of the filling chamber 6.

Airtightness inside the filling chamber 6 is ensured by filling liquid silicon in the filling chamber 6 as a filler. The seal cap 10 is formed annularly and attached to the cable 3. As this seal cap 10, the one with an inner diameter according to a cable diameter is used so that the filler in the filling chamber 6 does not leak along an outer periphery of the cable 3. The seal cap 10 is arranged between the cable drawing portion 7 and the rear holder 9 in a state assembled to the outer periphery of the cable 3. Even if the cable 3 with a different diameter is used, the seal cap 10 is used for prevention of leakage of the filler and waterproof from an outside.

### CITATION LIST

### Patent Literature

Patent Literature 1: Japanese Patent Laid-Open Publication No. 2011-228112

### SUMMARY OF INVENTION

### Technical Problem

However, the seal cap 10 has a slight clearance provided between itself and the outer periphery of the cable 3 for improvement of assembling performance to be moved in a longitudinal direction of the cable 3 for assembling when it is attached to the outer periphery of the cable 3. Thus, gaps L1 and L2 (see FIG. 20) are generated by vibration of the cable 3 between the cable drawing portion 7 and the seal cap 10 and between the rear holder 9 and the seal cap 10, which deteriorates waterproof performances.

Moreover, if gaps are generated by vibration between the cable drawing portion and the seal cap and between the rear holder and the seal cap, adhesiveness between the filler and the cable lowers, which also deteriorates the waterproof performances.

Thus, the present invention has an object to provide a waterproof connector which prevents deterioration of the waterproof performances in the cable drawing portion.

### Solution to Problem

The waterproof connector of the present invention is a waterproof connector having a fitting portion fitted with a mating connector; a connector housing including a filling chamber in which a connection portion between an end of a cable and a terminal is accommodated and a filler is filled and a cable drawing portion in which the cable is drawn out from an inside of the filling chamber; a rear holder assembled to the cable drawing portion and holding the drawn out cable together with the cable drawing portion; and a seal cap assembled to the cable between the cable drawing portion and the filling chamber and preventing outflow of the filler from the inside of the filling chamber, wherein a holding recess portion for deforming the seal cap and for bringing the seal cap into close contact with an outer periphery of the cable in a state in which the rear holder is assembled to the cable drawing portion is provided at the cable drawing portion and the rear holder.

In the waterproof connector of the present invention, the seal cap may be formed annularly so as to be externally fitted to the outer periphery of the cable and is brought into close contact with the outer periphery of the cable with an annular inner diameter of the seal cap being reduced in the state in which the rear holder is assembled to the cable drawing portion.

In the waterproof connector of the present invention, a gap may be formed in a part of an annular cap body of the seal cap and the annular inner diameter is reduced by reduction of the gap caused by assembling of the rear holder to the cable drawing portion.

In the waterproof connector of the present invention, both ends of the cap body may be formed in stepped shapes formed by overlapping ends projected from both ends of the cap body, respectively, to be overlapped with each other and circumferential ends formed on base portion sides of the overlapping ends, respectively, and forming gaps between end faces of the other overlapping ends and the circumferential ends, respectively.

In the waterproof connector of the present invention, the annular cap body of the seal cap may be formed of an inner annular portion brought into close contact with an outer periphery of the inserted cable, an outer annular portion held by the holding recess portion to be reduced in diameter, and an elastic connection portion connecting the inner annular portion and the outer annular portion to each other and reducing the diameter of the inner annular portion by a stress in a diameter-reducing direction from the outer annular portion which is held by the holding recess portions to be reduced in diameter, to bring the inner annular portion into close contact with the outer periphery of the cable.

### BRIEF DESCRIPTION OF DRAWINGS

FIG. 1 is an exploded perspective view illustrating a first embodiment of a waterproof connector according to the present invention.

FIG. 2A is a perspective view illustrating a state before a cable to which a cap seal is attached is assembled to a cable drawing portion in the first embodiment of the waterproof connector according to the present invention.

FIG. 2B is an IIB-IIB line sectional view of FIG. 2A.

FIG. 3A is a perspective view illustrating a state in which the cable to which the cap seal is attached is assembled to the cable drawing portion and before a rear holder is assembled to the cable drawing portion in the first embodiment of the waterproof connector according to the present invention.

FIG. 3B is a sectional view obtained by cutting a state illustrated in FIG. 3A at a place corresponding to the IIB-IIB line in FIG. 2A.

FIG. 4A is a perspective view illustrating a state in which the cable to which the cap seal is attached is held by the cable drawing portion and the rear holder in the first embodiment of the waterproof connector according to the present invention.

FIG. 4B is a sectional view obtained by cutting a state illustrated in FIG. 4A at a place corresponding to the IIB-IIB line in FIG. 2A.

FIG. 5A is a front view illustrating the cap seal in a state before being held by the cable drawing portion and the rear holder in the first embodiment.

FIG. 5B is a front view illustrating the cap seal in a state held by the cable drawing portion and the rear holder in the first embodiment.

FIG. 6A is a front view illustrating a cap seal in a state before being held by a cable drawing portion and a rear holder in a second embodiment.

FIG. 6B is a front view illustrating the cap seal in a state held by the cable drawing portion and the rear holder in the second embodiment.

FIG. 7A is a perspective view illustrating the cap seal in a state before being held by the cable drawing portion and the rear holder in the second embodiment.

FIG. 7B is a perspective view illustrating the cap seal in a state held by the cable drawing portion and the rear holder in the second embodiment.

FIG. 8A is a perspective view illustrating a cap seal in a state before being held by a cable drawing portion and a rear holder in a third embodiment.

FIG. 8B is a perspective view of the state illustrated in FIG. 8A.

FIG. 9A is a side view illustrating the cap seal in a state held by the cable drawing portion and the rear holder in the third embodiment.

FIG. 9B is a front view of the state illustrated in FIG. 9A.

FIG. 9C is a perspective view of the state illustrated in FIG. 9A.

FIG. 10A is a perspective view illustrating a state before a cable to which the cap seal is attached is assembled to the cable drawing portion in the third embodiment of the waterproof connector according to the present invention.

FIG. 10B is a perspective view illustrating a state in which the cable to which the cap seal is attached is assembled to the cable drawing portion and before a rear holder is assembled to the cable drawing portion in the third embodiment of the waterproof connector according to the present invention.

FIG. 10C is a perspective view illustrating a state in which the cable to which the cap seal is attached is held by the cable drawing portion and the rear holder in the third embodiment of the waterproof connector according to the present invention.

FIG. 11A is a front view illustrating the cap seal of the third embodiment in a state before the rear holder is assembled to the cable drawing portion.

FIG. 11B is a front view illustrating the cap seal of the third embodiment in a state in which the rear holder is assembled to the cable drawing portion and the cap seal is held by the cable drawing portion and the rear holder.

FIG. 12 is a perspective view illustrating a cap seal of a fourth embodiment.

FIG. 13A is a sectional view illustrating the cap seal in a state before being held by a cable drawing portion and a rear holder of the fourth embodiment.

FIG. 13B is a sectional view illustrating the cap seal in a state held by the cable drawing portion and the rear holder of the fourth embodiment.

FIG. 14 is a sectional view obtained by cutting a waterproof connector to which the cap seal of the fourth embodiment is assembled at a place along a cable.

FIG. 15 is a perspective view illustrating a cap seal of a fifth embodiment.

FIG. 16A is a sectional view illustrating the cap seal in a state before being held by a cable drawing portion and a rear holder of the fifth embodiment.

FIG. 16B is a sectional view illustrating the cap seal in a state held by the cable drawing portion and the rear holder of the fifth embodiment.

FIG. 17 is a sectional view obtained by cutting a waterproof connector to which the cap seal of the fifth embodiment is assembled at a place along a cable.

FIG. 18 is a perspective view illustrating a prior-art waterproof connector.

FIG. 19 illustrates the prior-art waterproof connector and is a XIX-XIX line sectional view of FIG. 18.

FIG. 20 is a sectional view of a part of the prior-art waterproof connector illustrated in FIG. 19 in an enlarged manner.

### DESCRIPTION OF EMBODIMENTS

Embodiments of the present invention will be described below by referring to the attached drawings. First, a waterproof connector to which seal caps 50, 60, 70, 80, and 90 with different shapes in first to fifth embodiments which will be described later are assembled will be described.

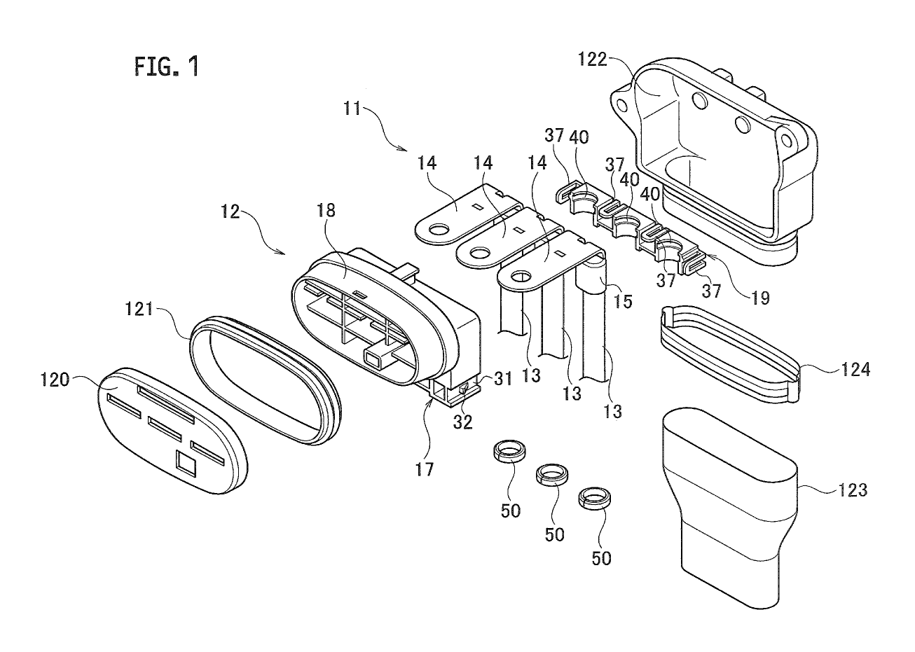

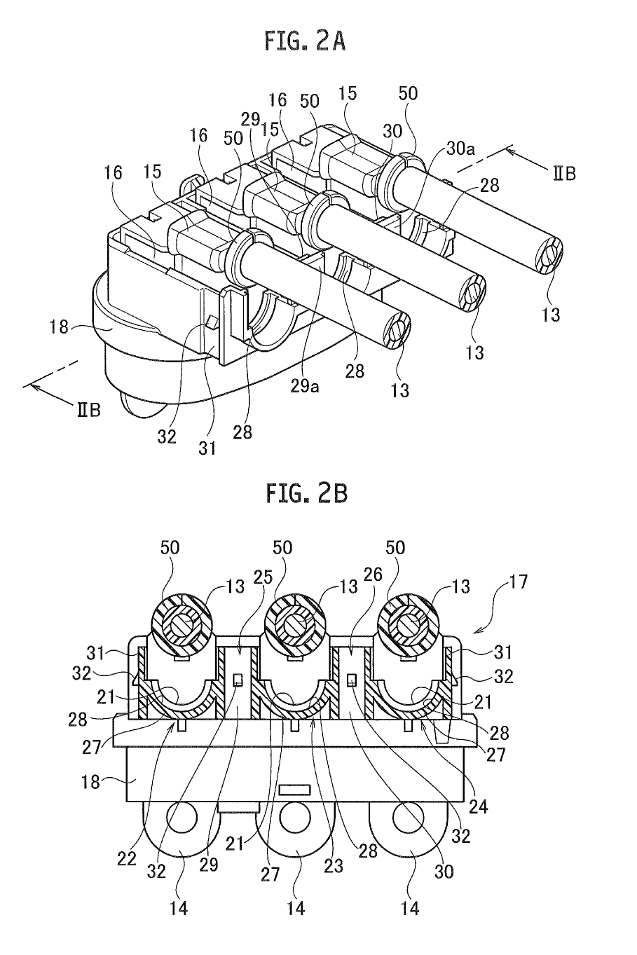

As illustrated in FIGS. 1, 2A, and 2B, the waterproof connector 11 to which the seal caps (50, 60, 70, 80, and 90) of each embodiment are assembled includes a fitting portion 12 fitted with a mating connector, a connector housing 18 in which a filling chamber 16 in which a connection portion 15 between an end of a cable 13 and a terminal 14 is accommodated and a filler is filled and a cable drawing portion 17 in which the cable 13 is drawn from an inside of the filling chamber 16 are formed. Moreover, the waterproof connector 11 has a rear holder 19 assembled to the cable drawing portion 17 and holding the drawn out cable 13 together with the cable drawing portion 17, and a seal cap (here, the seal cap 50 in the first embodiment is used) assembled to the cable 13 between the cable drawing portion 17 and the filling chamber 16 and preventing outflow of the filler from the inside of the filling chamber 16. Airtightness inside the filling chamber 16 is ensured by filling liquid silicon in the filling chamber 16 as a filler.

As illustrated in FIGS. 2A, 2B, 3A, 3B, 4A and 4B, holding recess portions 21 and 39 for deforming the seal caps 50, 60, 70, 80, and 90 and bringing these seal caps 50, 60, 70, 80, and 90 into close contact with an outer periphery of the cable 13 in a state in which the rear holder 19 is assembled to the cable drawing portion 17 are provided at the cable drawing portion 17 and the rear holder 19, respectively. FIGS. 2A, 2B, 3A, 3B, 4A and 4B illustrate a case in which the seal cap 50 of the first embodiment to be described later is used.

In the cable drawing portion 17, cable receiving portions 22, 23, and 24 are formed as illustrated in FIG. 2B. These cable receiving portions 22, 23, and 24 are arranged in parallel and the cable receiving portions 22 and 24 are located on both sides of the cable receiving portion 23 at a center. A holder attaching portion 25 for attaching the rear holder 19 is provided between the cable receiving portions 22 and 23, and a holder attaching portion 26 for attaching the rear holder 19 is provided between the cable receiving portions 23 and 24.

On front surface sides (side from which the cable is to be drawn out) of these holder attaching portions 25 and 26, fitting walls 29a and 30a are provided, respectively.

A lock frame portion 37 of the rear holder 19 which will be described later is inserted between the holder attaching portion 25 and the fitting wall 29a and between the holder attaching portion 26 and the fitting wall 30a.

There is a wall portion 29 on a front surface of the holder attaching portion 25, and there is a wall portion 30 on a front surface of the holder attaching portion 26, and in side surfaces of the cable receiving portion 22, there is a side surface wall portion 31 on a surface directed to a direction facing an outside of the waterproof connector 11. Similarly, there is the side surface wall portion 31 also on a surface directed to the outside of the waterproof connector 11 in side surfaces of the cable receiving portion 24. Lock projections 32 are projected on the wall portion 29, the wall portion 30, and the two side surface wall portions 31. The rear holder 19 is assembled to these holder attaching portions 25 and 26, and the rear holder 19 is attached to the holder attaching portions 25 and 26 by the lock projections 32.

As illustrated in FIG. 2B, in the cable receiving portion 22, a receiving wall 27 having a semicircular (arc-shaped) section is provided following the outer periphery of the cable 13 and the holding recess portion 21 is formed. On an inner periphery of this receiving wall 27, an accommodating groove 28 over a semicircle is provided. A semicircle of the seal cap 50 is accommodated in the accommodating groove 28. The holding recess portion 21 is also formed in the other cable receiving portions 23 and 24 similarly to the cable receiving portion 22.

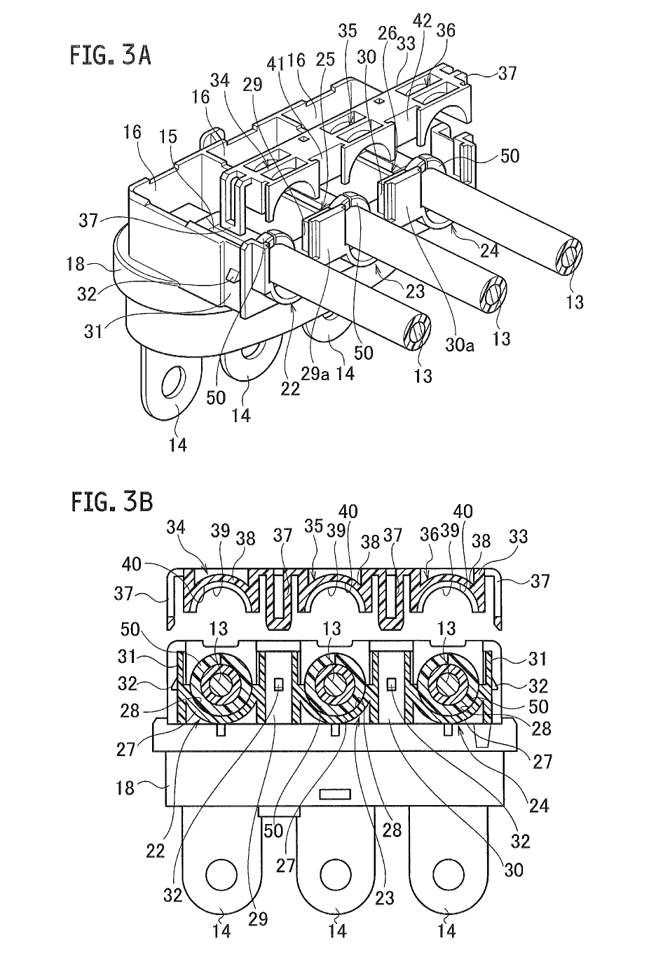

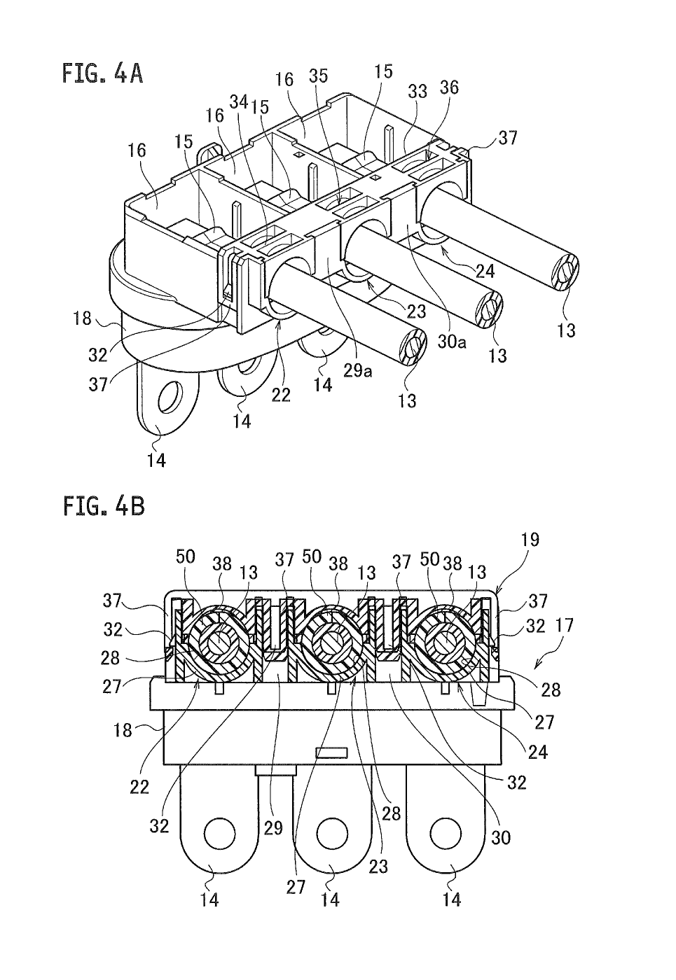

The rear holder 19 has, as illustrated in FIGS. 3A, 3B, 4A and 4B, a holder body 33 and cap pressing portions 34, 35, and 36 at three spots projected from this holder body 33 in a same direction formed. On a rear surface side of the rear holder 19 (a side opposite to a side from which the cable is drawn out) and between the adjacent cap pressing portions 34 and 35 and between the adjacent cap pressing portions 35 and 36, the lock frame portion 37 is formed, respectively, and on a front surface side (the side from which the cable is drawn out), fitting grooves 41 and 42 are provided. In these fitting grooves 41 and 42, the fitting walls 29a and 30a provided among the cable receiving portions 22, 23, and 24 of the cable drawing portion 17 are made to slide from above in FIGS. 3A and 3B and fitted, and the rear holder 19 is positioned with respect to the cable drawing portion.

The lock frame portion 37 is provided on the surface directed to the outside of the waterproof connector 11 in the side surfaces of the cap pressing portion 34, and similarly, the lock frame portion 37 is also provided on the surface directed to the outside of the waterproof connector 11 in the side surfaces of the cap pressing portion 36. That is, the lock frame portion 37 is provided on both side surfaces of the rear holder 19.

In the cap pressing portion 34, a pressing wall 38 having a semicircular (arc-shaped) section following the outer periphery of the cable 13 is provided, and the holding recess portion 39 is formed. An accommodating groove 40 over a semicircle is provided in an inner periphery of this pressing wall 38. A semicircle of the seal cap 50 is accommodated in the accommodating groove 40. In the other cap pressing portions 35 and 36, too, the holding recess portion 39 is formed similarly to the cap pressing portion 34.

As illustrated in FIGS. 3A and 3B, the semicircle on a lower half of the seal cap 50 is accommodated in the accommodating groove 28 of the holding recess portion 21 of the cable drawing portion 17, whereby the cable 13 to which the seal cap 50 is attached is arranged in the cable receiving portions 22, 23, and 24. From this state, the semicircle on an upper half of the seal cap 50 is accommodated in the accommodating groove 40 of the holding recess portion 39 of the rear holder 19, and the seal cap 50 attached to the cable 13 is pressed by the cap pressing portions 34, 35, and 36.

By assembling the rear holder 19 to the cable drawing portion 17, the seal cap 50 is accommodated between the holding recess portion 21 and the holding recess portion 39. Then, the seal cap 50 is held between the cable receiving portions 22, 23, and 24 and the corresponding cap pressing portions 34, 35, and 36. At this time, the seal cap 50 is deformed (reduced in diameter) and assembled between the cable drawing portion 17 and the rear holder 19 in a state in which an inner periphery side of this seal cap 50 is in close contact with the outer periphery of the cable 13.

FIG. 1 illustrates a front holder 120, a packing 121, a shield shell 122, a strand 123, and a seal ring 124.

The seal cap 50 and the seal caps 60, 70, 80, and 90 in other embodiments will be described below. All the seal caps 50, 60, 70, 80, and 90 are integrally molded of an elastic body having elasticity such as rubber.

### First Embodiment

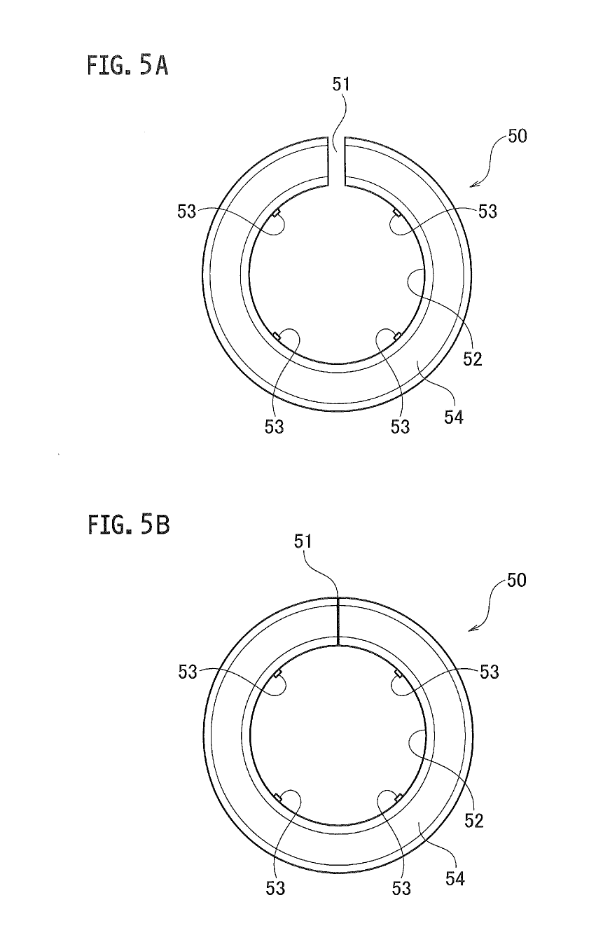

As illustrated in FIG. 5A, the seal cap 50 in a first embodiment is formed annularly, and a slit (gap) 51 is formed in a part of a circumferential direction in a direction orthogonal to the circumferential direction, that is, in a radial direction. Moreover, on an inner peripheral surface 52, four small projections 53 are projected at equal intervals in the circumferential direction.

Then, before the seal cap 50 is assembled to the waterproof connector 11, that is, in a state before it is assembled to the holding recess portion 21 of the cable drawing portion 17 and the holding recess portion 39 of the rear holder 19, as illustrated in FIG. 5A, the slit (gap) 51 is present in a part of an outer periphery. By attaching the seal cap 50 to the outer periphery of the cable 13 and by assembling the seal cap 50 between the holding recess portion 21 of the cable drawing portion 17 and the holding recess portion 39 of the rear holder 19 in this state, the seal cap 50 is dammed, and as illustrated in FIG. 5B, an interval of the slit (gap) 51 is made smaller, and the diameter of the seal cap 50 is reduced. When the diameter of the seal cap 50 is reduced, the inner peripheral surface 52 of the seal cap 50 is brought into close contact with the outer periphery of the cable 13.

When the rear holder 19 is assembled to the cable drawing portion 17, the cable is held between the holding recess portion 21 of the cable drawing portion 17 and the holding recess portion 39 of the rear holder 19. In this state, the seal cap is deformed and the seal cap is brought into close contact with the outer periphery of the cable. As a result, since the seal cap 50 is in close contact also with the cable drawing portion 17 and the rear holder 19, no clearance is generated between the seal cap 50 and the cable drawing portion 17 and between the seal cap 50 and the rear holder 19. Thus, even if the cable 13 is vibrated, drop of the waterproof performances in the cable drawing portion 17 can be prevented.

Moreover, since the seal cap 50 of this embodiment has the slit (gap) 51 formed in a part of the circumferential direction, when the seal cap is to be attached to the cable 13, it is only necessary that the cable 13 is inserted into the inner diameter portion through this slit (gap) 51 without requiring insertion from an end of the cable 13, and an attaching work to the cable 13 is facilitated.

### Second Embodiment

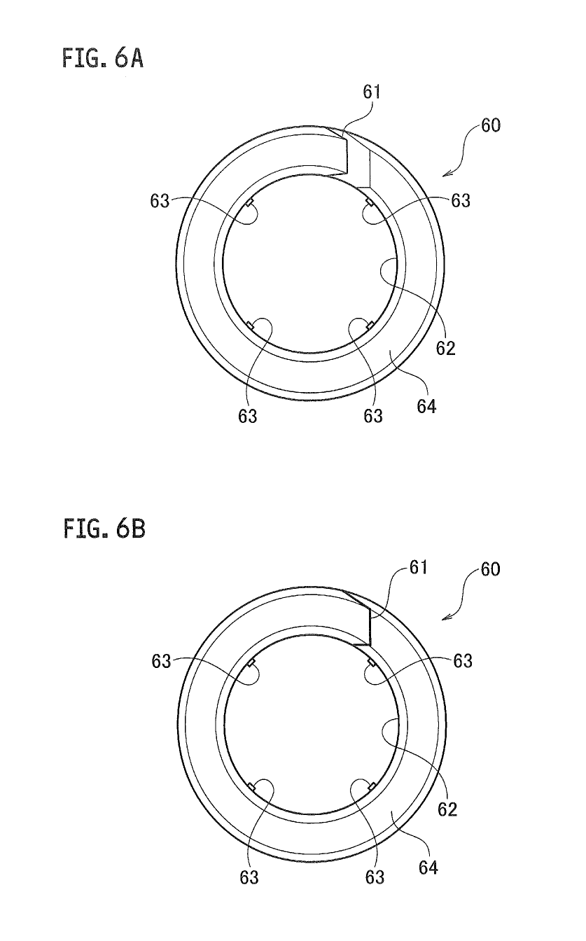

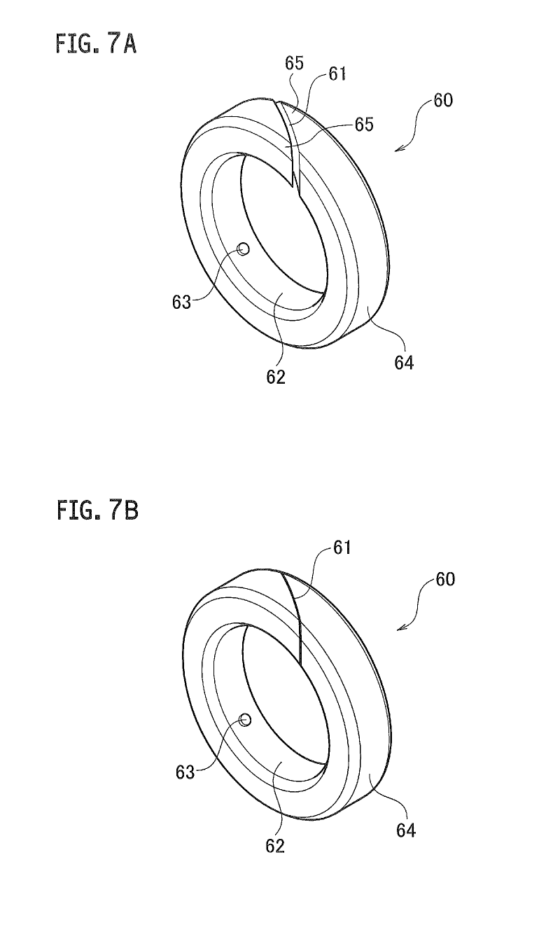

Subsequently, a second embodiment will be described. As illustrated in FIGS. 6A and 7A, the seal cap 60 of the second embodiment is formed annularly, and a slit (gap) 61 along a direction crossing the circumferential direction, that is, along an inclination direction is formed in a part of the circumferential direction. In this gap 61, both ends 65 and 65 are overlapped in an axial direction of the seal cap 60 (an axial direction of the cable when being attached to the cable 13). Moreover, four small projections 63 are projected at equal intervals in the circumferential direction on an inner peripheral surface 62.

Then, before the seal cap 60 is assembled to the waterproof connector 11, that is, in a state before the seal cap is assembled to the holding recess portion 21 of the cable drawing portion 17 and the holding recess portion 39 of the rear holder 19, as illustrated in FIGS. 6A and 7A, the slit (gap) 61 is present in a part of the outer periphery. By attaching the seal cap 60 to the outer periphery of the cable 13 and by assembling it to the holding recess portion 21 of the cable drawing portion 17 and the holding recess portion 39 of the rear holder 19 in this state, the seal cap 60 is deformed, and as illustrated in FIGS. 6B and 7B, the interval of the slit (gap) 61 is made smaller, and the diameter is reduced. When the diameter of the seal cap 60 is reduced, the inner peripheral surface 62 of the seal cap 60 is brought into close contact with the outer periphery of the cable 13.

As a result, since the seal cap 60 is in close contact also with the cable drawing portion 17 and the rear holder 19, no clearance is generated between the seal cap 60 and the cable drawing portion 17 and between the seal cap 60 and the rear holder 19, and thus, drop of waterproof performances in the cable drawing portion 17 can be prevented even if the cable 13 is vibrated.

Moreover, in this embodiment, too, in the seal cap 60 of this embodiment, since the slit (gap) 61 is formed in a part of the circumferential direction, when the seal cap is to be attached to the cable 13, it is only necessary that the cable 13 is inserted into the inner diameter portion through this slit (gap) 61 without requiring insertion from an end of the cable 13, and the attaching work to the cable 13 is facilitated.

Moreover, in the seal cap 60 of this embodiment, since the slit (gap) 61 is provided with inclination, the end portions 65 and 65 on the both sides of the slit (gap) 61 of the seal cap 60 are overlapped with each other. That is, though the slit (gap) 51 of the seal cap 50 of the first embodiment is the slit 51 penetrating along the axial direction of the cable 13, the slit 61 in the seal cap 60 of the second embodiment has the both end portions 65 and 65 of the slit 61 overlapped with each other and is not penetrating in the axial direction of the cable 13 and thus, leakage of the filler can be further prevented.

### Third Embodiment

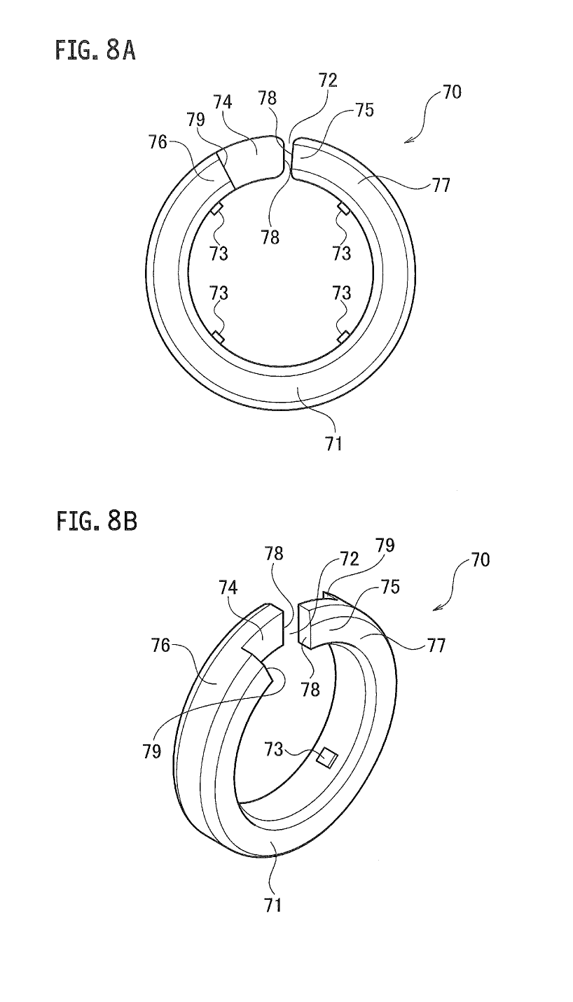

Subsequently, a third embodiment will be described. As illustrated in FIGS. 8A and 8B, the cap seal 70 of the third embodiment has a slit (gap) 72 formed in a part of an annular cap body 71, and reduction of the slit (gap) 72 caused by assembling of the rear holder 19 to the cable drawing portion 17 reduces an annular inner diameter.

On both ends of the cap body 71, overlapping ends 74 and 75 projected from both ends of the cap body 71, respectively, and overlapping each other are formed, and a tip end surface 78 is formed on an end of each of these overlapping ends 74 and 75. On each of base portions 76 and 77 sides of the overlapping ends 74 and 75, a circumferential end 79 forming a gap 72 between itself and the tip end surface 78 of the other overlapping ends 74 and 75 is formed, respectively. As illustrated in FIG. 8B, the both ends of the cap body 71 are formed in a stepped shape by the tip end surfaces 78, the overlapping ends 74 and 75, and the circumferential ends 79.

Moreover, the overlapping ends 74 and 75 on the both ends are formed alternately, and the tip end surfaces 78 of the overlapping ends 74 and 75 face the circumferential ends 79 of the other overlapping ends 74 and 75, respectively. Then, in a state not being held between the cable drawing portion 17 and the rear holder 19, the gaps 72 are formed between the tip end surfaces 78 of the overlapping ends 74 and 75 and the other circumferential ends 79 as described above.

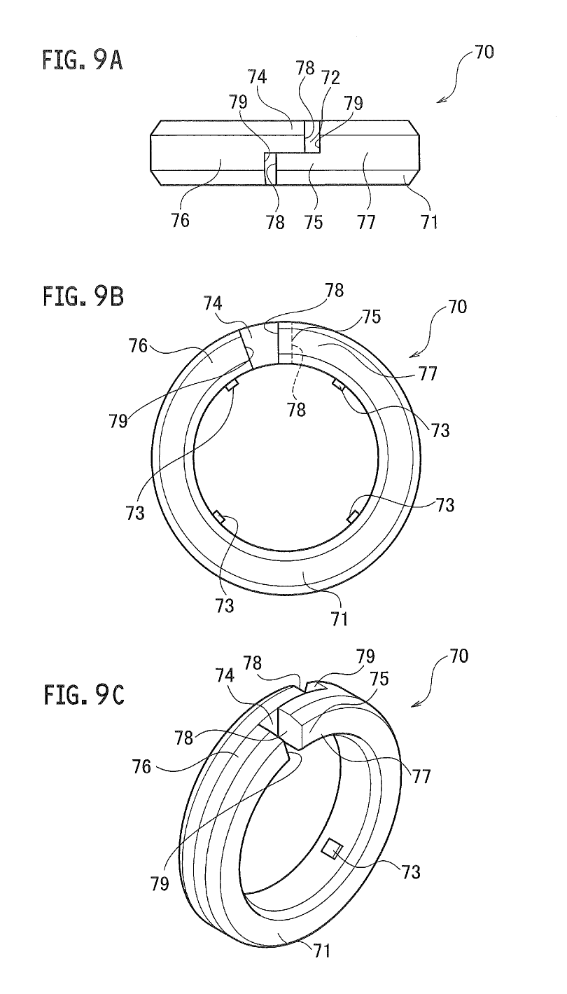

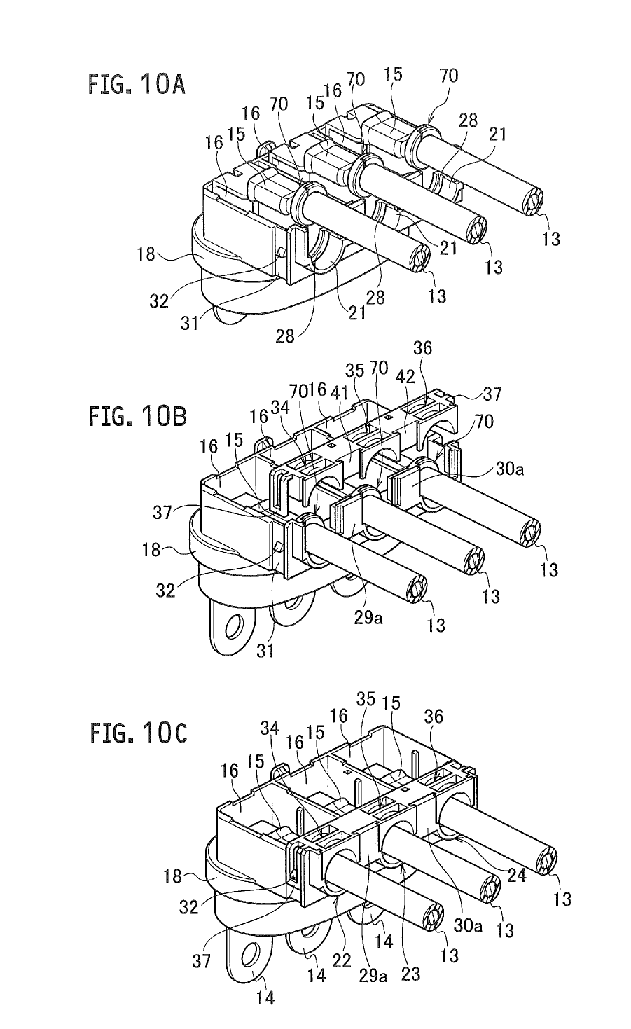

Then, before the cap seal 70 is assembled to the waterproof connector 11, that is, in a state before the cap seal is assembled to the holding recess portion 21 of the cable drawing portion 17 and the holding recess portion 39 of the rear holder 19, as illustrated in FIGS. 8A and 8B, the slit (gap) 72 is present in a part of the outer periphery. By attaching the seal cap 70 to the outer periphery of the cable 13 and by assembling it to the holding recess portion 21 of the cable drawing portion 17 and the holding recess portion 39 of the rear holder 19 in this state, the seal cap 70 is deformed, and as illustrated in FIGS. 9A, 9B and 9C, the interval of the gap 72 is made smaller, and the inner diameter is reduced. When the diameter of the seal cap 70 is reduced, the inner periphery of the seal cap 70 is brought into close contact with the outer periphery of the cable 13.

As a result, since the seal cap 70 is in close contact also with the cable drawing portion 17 and the rear holder 19, no clearance is generated between the seal cap 70 and the cable drawing portion 17 and between the seal cap 70 and the rear holder 19, and thus, drop of waterproof performances in the cable drawing portion 17 can be prevented even if the cable 13 is vibrated.

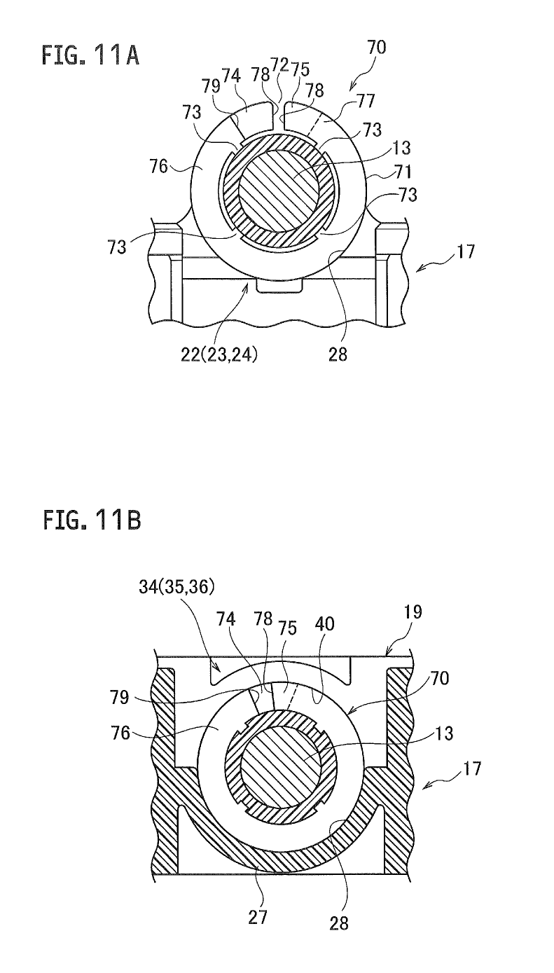

Moreover, in the seal cap 70 of this embodiment, in a state not held between the cable drawing portion 17 and the rear holder 19, the slit (gap) 72 is formed as illustrated in FIG. 11A, but if held between the holding recess portion 21 of the cable drawing portion 17 and the holding recess portion 39 of the rear holder 19 as illustrated in FIG. 11B and the inner diameter is reduced, the overlapping ends 74 and 75 are overlapped with each other in the axial direction of the cable 13. That is, the slit 51 of the seal cap 50 of the first embodiment is the slit 51 penetrating along the axial direction of the cable 13, the slit (gap) 72 in the seal cap 70 of the third embodiment has the overlapping ends 74 and 75 overlapped with each other and not the slit (gap) 72 penetrating in the axial direction of the cable 13 and thus, leakage of the filler can be reliably prevented.

Moreover, in this embodiment, too, in the seal cap 70 of this embodiment, since the slit (gap) 72 is formed in a part of the circumferential direction, when the seal cap is to be attached to the cable 13, it is only necessary that the cable 13 is inserted into the inner diameter portion through this gap 72 without requiring insertion from an end of the cable 13, and the attaching work to the cable 13 is facilitated.

### Fourth Embodiment

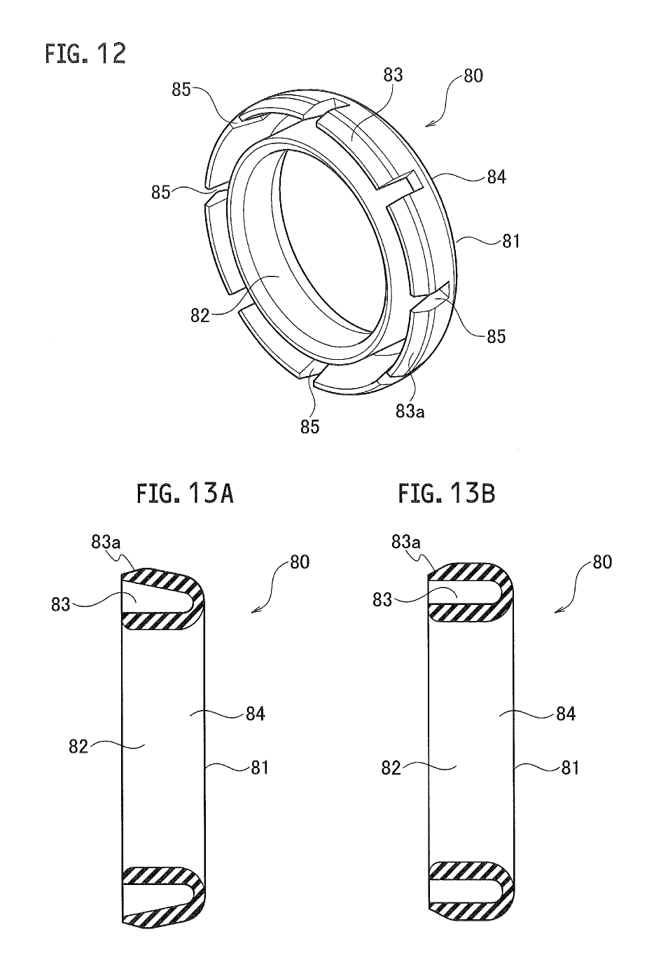

Subsequently, a fourth embodiment will be described. As illustrated in FIGS. 12, 13A, and 13B, the seal cap 80 of the fourth embodiment is formed annularly so as to be externally fitted with the outer periphery of the cable 13, and an annular inner diameter of the seal cap 80 is reduced and brought into close contact with the outer periphery of the cable 13 in a state in which the rear holder 19 is assembled to the cable drawing portion 17.

An annular cap body 81 of the seal cap 80 is Ruined of an inner annular portion 82 to be brought into close contact with the outer periphery of the inserted cable 13, an outer annular portion 83 held between the holding recess portion 21 of the cable drawing portion 17 and the holding recess portion 39 of the rear holder 19 to be reduced in diameter, and an elastic connection portion 84 connecting the inner annular portion 82 and the outer annular portion 83 to each other. The elastic connection portion 84 reduces the diameter of the inner annular portion 82 by a stress in a diameter-reducing direction from the outer annular portion 83 held by the holding recess portions 21 and 39 to be reduced in diameter and brings the inner annular portion 82 into close contact with the outer periphery of the cable 13.

The inner annular portion 82 is formed by one wall surface continuing over an entire region in the circumferential direction, and the elastic connection portion 84 is extended on one side of this inner annular portion 82. Moreover, the outer annular portion 83 is extended on the elastic connection portion 84 so as to surround the inner annular portion 82, and one side of the outer annular portion 83 is connected to the elastic connection portion 84. As illustrated in FIGS. 13A and 13B, the inner annular portion 82, the elastic connection portion 84, and the outer annular portion 83 are integrally formed and each is formed having a U-shaped section. An inclined surface 83a is formed on an outer peripheral surface on the other side (tip end side) of the outer annular portion 83, and eight rectangular notches 85 are formed at equal intervals in the circumferential direction.

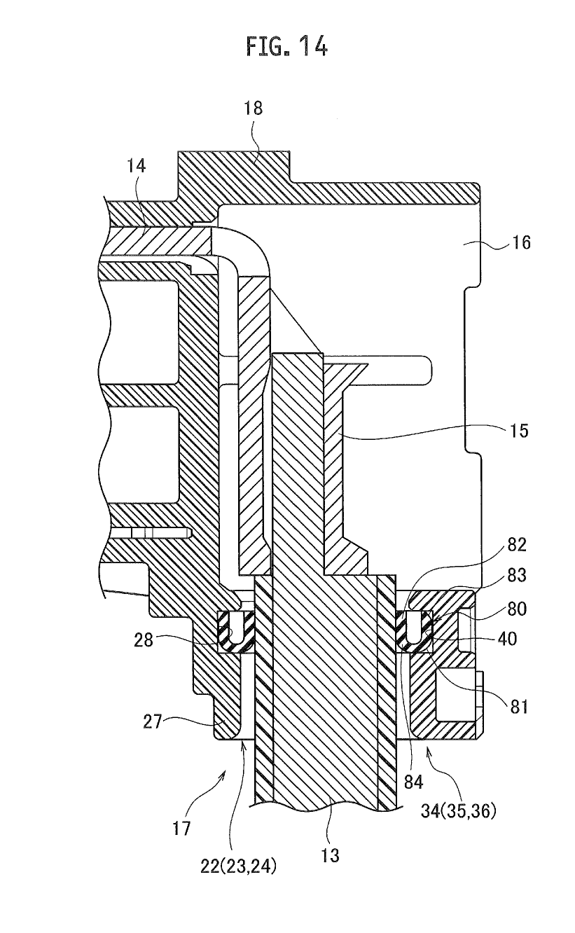

In a state before the seal cap 80 is assembled to the waterproof connector 11, that is, in a state before being assembled to the holding recess portion 21 of the cable drawing portion 17 and the holding recess portion 39 of the rear holder 19, as illustrated in FIG. 13A, the other sides of the inner annular portion 82 and the outer annular portion 83 are spaced away (open) from each other. In a state in which the seal cap 80 is assembled to the waterproof connector 11, that is, if the seal cap 80 is held by the holding recess portion 21 of the cable drawing portion 17 and the holding recess portion 39 of the rear holder 19, as illustrated in FIGS. 13B and 14, the outer annular portion 83 is entirely pressed inward and reduced in diameter, and when the diameter of the outer annular portion 83 is reduced, the elastic connection portion 84 is deformed, and by means of the deformation of the elastic connection portion 84, the inner annular portion 82 is pressed toward the outer peripheral surface of the cable 13 and the inner annular portion 82 is brought into close contact with the outer periphery of the cable 13.

As a result, since no clearance is generated between the seal cap 80 and the cable drawing portion 17 and between the seal cap 80 and the rear holder 19, drop of the waterproof performances in the cable drawing portion 17 can be prevented even if the cable 13 is vibrated.

Moreover, since the outer annular portion and the inner annular portion surround the periphery of the cable in the entire region in the circumferential direction, a gap is not generated in the circumferential direction of the cable and drop of the waterproof performances can be further prevented.

### Fifth Embodiment

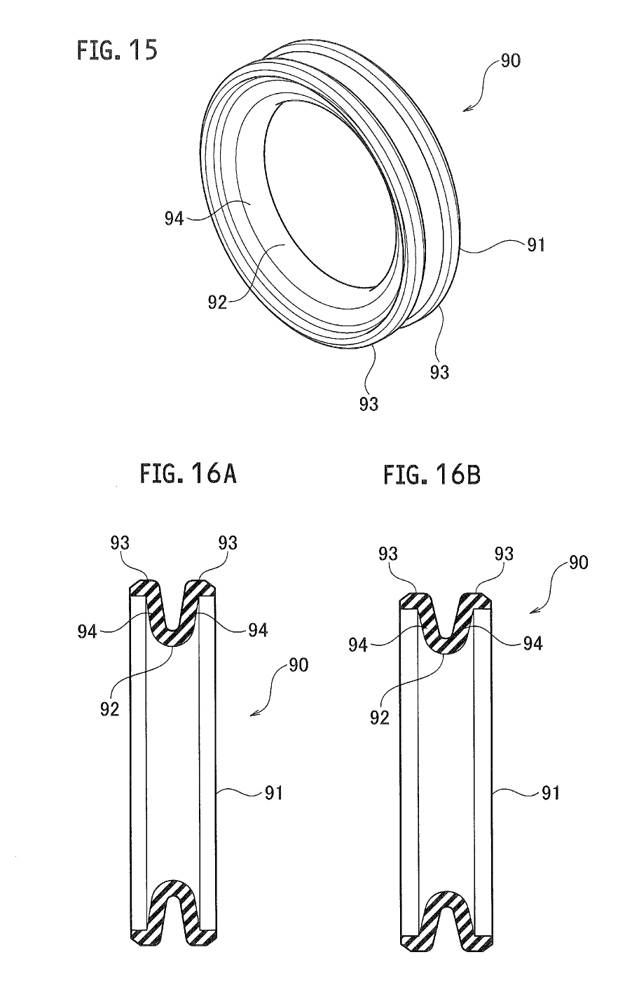

A fifth embodiment will be described. As illustrated in FIGS. 15, 16A, and 16B, the seal cap 90 of the fifth embodiment is formed annularly so as to be externally fitted with the outer periphery of the cable 13, and the seal cap 90 is brought into close contact with the outer periphery of the cable 13 with an annular inner diameter of the seal cap 90 being reduced in a state in which the rear holder 19 is assembled to the cable drawing portion 17.

An annular cap body 91 of the seal cap 90 is formed, having a V-shaped sectional shape, of an inner annular portion 92 to be brought into close contact with the outer periphery of the inserted cable 13, an outer annular portion 93 held between the holding recess portion 21 of the cable drawing portion 17 and the holding recess portion 39 of the rear holder 19 to be reduced in diameter, and elastic connection portions 94 and 94 connecting the inner annular portion 92 and the outer annular portion 93 to each other and bringing the inner annular portion 92 into close contact with the outer periphery of the cable 13 with the diameter of the inner annular portion 92 being reduced by a stress in a diameter-reducing direction from the outer annular portion 93 held by the holding recess portions 21 and 39 to be reduced in diameter. The outer annular portion 93 is provided on a tip end side of the elastic connection portions 94 extended on both sides of the inner annular portion 92.

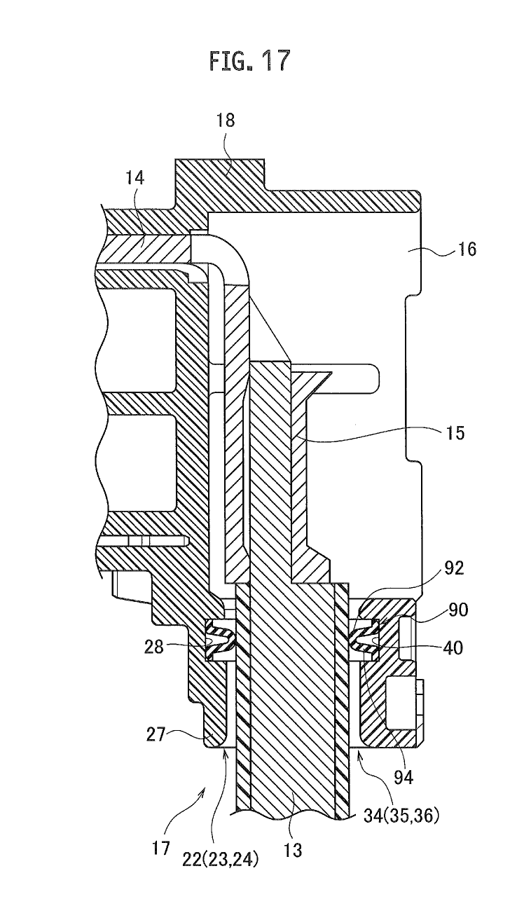

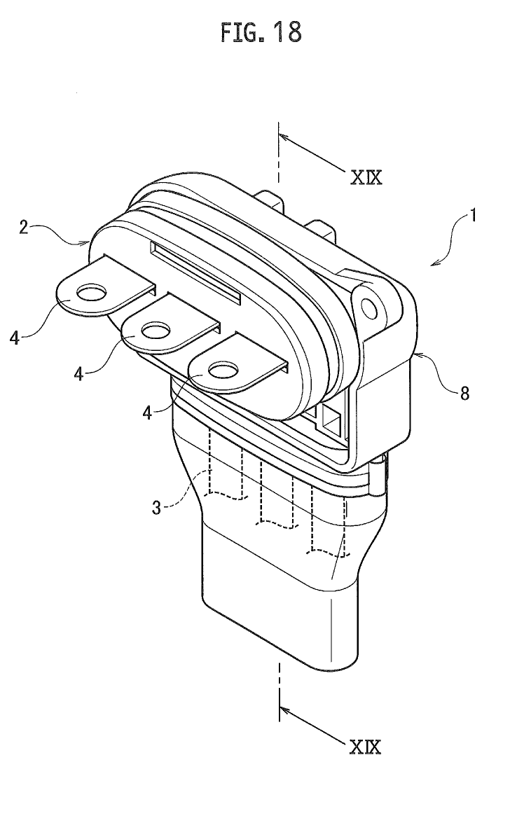

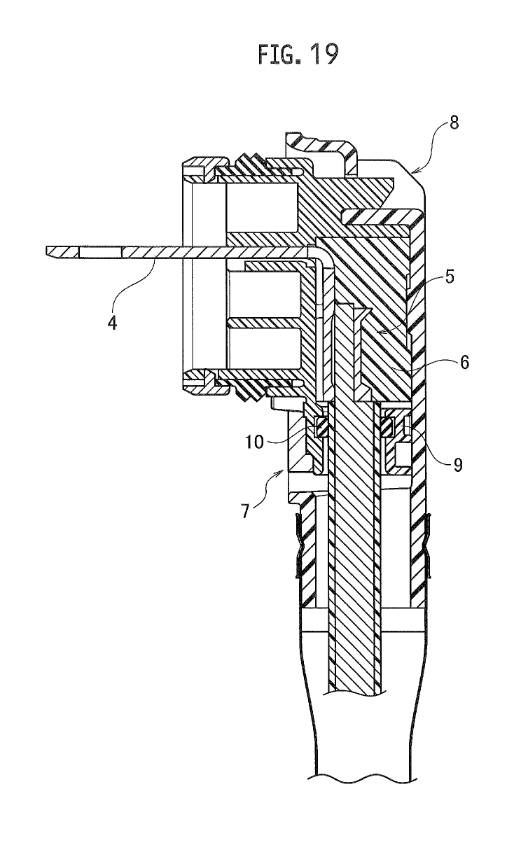

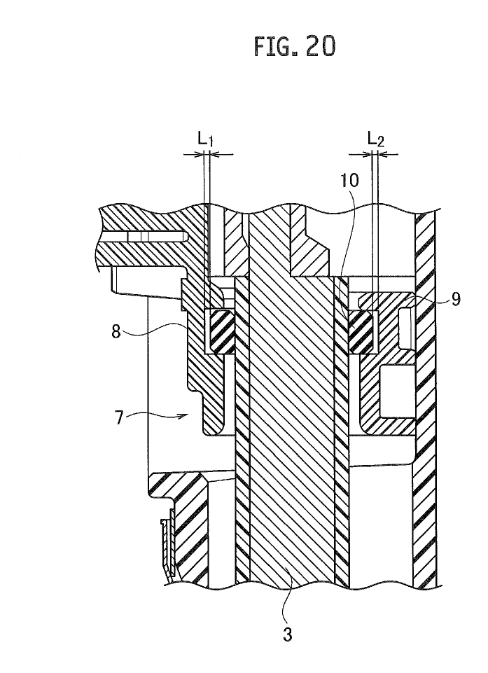

Before the seal cap 90 is assembled to the waterproof connector 11, that is, in a state before being assembled to the holding recess portion 21 of the cable drawing portion 17 and the holding recess portion 39 of the rear holder 19, as illustrated in FIG. 16A, the outer annular portion 93 of the seal cap 90 is extended outward, and if the seal cap 90 is held by the holding recess portion 21 of the cable drawing portion 17 and the holding recess portion 39 of the rear holder 19, as illustrated in FIGS. 16B and 17, the outer annular portion 93 is pressed and reduced in diameter, and when the diameter of the outer annular portion 93 is reduced, the elastic connection portions 94 and 94 are deformed, and by means of the deformation of the elastic connection portions 94 and 94, the inner annular portion 92 is reduced in diameter and pressed toward the outer peripheral surface of the cable 13 and the inner annular portion 92 is brought into close contact with the outer periphery of the cable 13.

As a result, since no clearance is generated between the seal cap 90 and the cable drawing portion 17 and between the seal cap 90 and the rear holder 19, drop of the waterproof performances in the cable drawing portion 17 can be prevented even if the cable 13 is vibrated.

Moreover, since the outer annular portion 93 and the inner annular portion 92 surround the periphery of the cable in the entire region in the circumferential direction, a gap is not generated in the circumferential direction of the cable 13 and drop of the waterproof performances can be further prevented.

Moreover, in the waterproof connector 11 to which the present invention is applied, the seal caps 50, 60, 70, 80, and 90 of the first embodiment to the fifth embodiment are held by the holding recess portion 21 of the cable drawing portion 17 and the holding recess portion 39 of the rear holder 19, whereby the seal caps 50, 60, 70, 80, and 90 are reduced in diameter and brought into close contact with the outer periphery of the cable and thus, a change of a cable size (thickness) can be handled by setting products with different inner diameters of the seal caps 50, 60, 70, 80, and 90 without newly providing/changing the rear holder 19 according to the cable size.

The seal caps of the first to the fifth embodiments were described above, but the shape may be any shape as long as it is deformed (reduced in diameter) between the holding recess portion 21 of the cable drawing portion 17 and the holding recess portion 39 of the rear holder 19 and brought into close contact with the outer periphery of the cable.

The embodiments of the present invention were described above, but these embodiments are mere exemplification described for facilitating understanding of the present invention and the present invention is not limited to the embodiments. A technical scope of the present invention is not limited to specific technical matters disclosed in the embodiments but includes various variations, changes and alternative technologies that can be easily derived therefrom.

### INDUSTRIAL APPLICABILITY

In the waterproof connector according to the present invention, when the rear holder is assembled to the cable drawing portion, the cable is held between the holding recess portions of the cable drawing portion and the rear holder. In this state, since the seal cap is deformed and the seal cap is brought into close contact with the outer periphery of the cable, no clearance is generated between the seal cap and the cable drawing portion and between the seal cap and the rear holder, and drop of the waterproof performances in the cable drawing portion can be prevented even if the cable is vibrated.

### REFERENCE SIGNS LIST

11 waterproof connector
12 fitting portion
13 cable
14 terminal
15 connection portion
16 filling chamber
17 cable drawing portion
18 connector housing
19 rear holder
21, 39 holding recess portion
50, 60, 70, 80, 90 seal cap

1. A waterproof connector comprising:
a fitting portion fitted with a mating connector;
a connector housing including a filling chamber in which a connection portion between an end of a cable and a terminal is accommodated and a filler is filled and a cable drawing portion in which the cable is drawn out from an inside of the filling chamber;
a rear holder assembled to the cable drawing portion and holding the drawn out cable together with the cable drawing portion; and
a seal cap assembled to the cable between the cable drawing portion and the filling chamber and preventing outflow of the filler from the inside of the filling chamber, wherein
a holding recess portion for deforming the seal cap and for bringing the seal cap into close contact with an outer periphery of the cable in a state in which the rear holder is assembled to the cable drawing portion is provided at the cable drawing portion and the rear holder.

2. The waterproof connector according to claim 1, wherein
the seal cap is formed annularly so as to be externally fitted to the outer periphery of the cable and is brought into close contact with the outer periphery of the cable with an annular inner diameter of the seal cap being reduced in the state in which the rear holder is assembled to the cable drawing portion.

3. The waterproof connector according to claim 1, wherein
a gap is formed in a part of an annular cap body of the seal cap and the annular inner diameter is reduced by reduction of the gap caused by assembling of the rear holder to the cable drawing portion.

4. The waterproof connector according to claim 3, wherein
both ends of the cap body are formed in stepped shapes formed by overlapping ends projected from both ends of the cap body, respectively, to be overlapped with each other and circumferential ends formed on base portion sides of the overlapping ends, respectively, and forming gaps between end faces of the other overlapping ends and the circumferential ends, respectively.

5. The waterproof connector according to claim 2, wherein
the annular cap body of the seal cap is formed of an inner annular portion brought into close contact with an outer periphery of the inserted cable, an outer annular portion held by the holding recess portion to be reduced in diameter, and an elastic connection portion connecting the inner annular portion and the outer annular portion to each other and reducing the diameter of the inner annular portion by a stress in a diameter-reducing direction from the outer annular portion which is held by the holding recess portions to be reduced in diameter, to bring the inner annular portion into close contact with the outer periphery of the cable.
